(19) United States
(12) Patent Application Publication
(10) Pub. No.: US 2020/0193176 A1
(43) Pub. Date: Jun. 18, 2020

(54) AUTOMATIC DRIVING CONTROLLER AND METHOD

(71) Applicant: HITACHI AUTOMOTIVE SYSTEMS, LTD., Hitachinaka-shi, Ibaraki (JP)

(72) Inventor: Yuya TANAKA, Hitachinaka-shi (JP)

(73) Assignee: HITACHI AUTOMOTIVE SYSTEMS, LTD., Hitachinaka-shi, Ibaraki (JP)

(21) Appl. No.: 16/643,875

(22) PCT Filed: Sep. 25, 2018
(86) PCT No.: PCT/JP2018/035280

§ 371 Date: Mar. 3, 2020

(30) Foreign Application Priority Data
Sep. 29, 2017 (JP) 2017-190476

(51) Int. Cl. G06K 9/00; B60W 60/00; G01C 21/30; G05D 1/02

(52) U.S. Cl. CPC G06K 9/00798; B60W 60/0015; G05D 2201/0213; G01C 21/30; G05D 1/0223; B60W 60/0027

(57) ABSTRACT

An automatic driving controller performs automatic driving using map information. A controller comprises an input unit for inputting vehicle sensor information, position information on a map, and map information, recognition processing in which information for automatic driving is set, and control processing in which information from the recognition processing provides operation target amounts for vehicle control units such as an engine, steering and brakes. The recognition processing comprises: a first unit for correcting the vehicle position information on a map; a second unit for positioning reference points at prescribed intervals on a road center line; a third unit for extracting, at the reference points, points where a line perpendicular to the road center line direction and road width lines intersect; a fourth unit for positioning lane markers at the extracted points; and a fifth unit for adjusting the prescribed intervals according to the road type or speed.

### TECHNICAL FIELD

The present invention relates to automatic driving controller, automatic driving controller, and method for performing automatic driving using map information, and particularly to automatic driving controller and method capable of providing appropriate lane boundary lines corresponding to a curve.

### BACKGROUND ART

In recent years, vehicle automatic driving realized by vehicles equipped with automatic driving control systems has been put to practical use, and various studies and proposals have been made on implementation techniques thereof.

One of these studied items is a stable traveling technique on a curve. For example, PTL 1 proposes a technique for reducing a speed before entering a curve. PTL 2 proposes a technique for accurately performing real-time lane detection at the time of traveling on a curve.

### CITATION LIST

### Patent Literature

PTL 1: JP 2008-12975 A

PTL 2: JP 2016-45144 A

### SUMMARY OF INVENTION

### Technical Problem

In the course of developing an automatic driving control system, conventionally, automatic driving on a highway has been targeted, and only a high speed range has been targeted as a region of a vehicle speed of a vehicle. For this reason, a lane boundary line and a point sequence interval of center points are assumed as fixed values.

In the future, however, it is necessary to conduct studies even regarding a case where the region of the vehicle speed of the vehicle is in a low speed range, and particularly, it is necessary to assume a curve with a small radius of curvature, a right/left turn at an intersection, and a right/left turn at a parking lot.

In these cases, a moving distance of the vehicle is short if the vehicle speed of the vehicle is low, and the vehicle fails to travel along a lane shape at the curve with the small radius of curvature and is likely to departure a lane if an interval between lane boundary lines is long. Further, if intervals of lane boundary lines and a point sequence of center points are uniformly shortened, the number of point sequences increases, and the amount of data communication provided to the control becomes a problem.

For this reason, in order to enable traveling in the low speed range, there are items that need to be solved such as providing information so as not to cause lane departure even in the low speed range as a guarantee of safety, preventing an increase in the amount of information to be provided as prevention of the increase in the amount of information, and preventing frequent change of the interval as the simplification of the control processing.

In view of the above circumstances, an object of the present invention is to provide automatic driving controller and method capable of appropriately setting a lane boundary line according to a curve, particularly when traveling at a low speed.

### Solution to Problem

In view of the above circumstances, in the present invention, there is provided “an automatic driving controller for performing automatic driving using map information, the controller including: an input unit for inputting at least vehicle sensor information, vehicle position information on a map, and map information; recognition processing in which information for automatic driving is set by processing the information from the input unit; and control processing in which information from the recognition processing is used to provide operation target amounts for vehicle control units such as an engine, steering and brakes. The recognition processing is provided with: a first means for correcting the vehicle position information on a map using the vehicle sensor information; a second means for positioning reference points at prescribed intervals on a road center line described by the map information; a third means for extracting, at the reference points, points where a line perpendicular to the road center line direction and road width lines intersect; a fourth means for positioning lane markers at the extracted points; and a fifth means for adjusting the prescribed intervals according to the road type or speed”.

Further, there is provided “an automatic driving control method for performing automatic driving using at least vehicle sensor information, vehicle position information on a map, and map information, the method including: correcting the vehicle position information on the map using the vehicle sensor information; positioning reference points at prescribed intervals on a road center line described in the map information; extracting, at the reference points, points where a line perpendicular to a direction of the road center line and road width lines intersect; positioning lane markers at the extracted points; and adjusting the prescribed intervals according to a road type or a speed”.

Further, there is provided “an automatic driving control method for performing automatic driving using map information, the method including adjusting prescribed intervals according to a road type or a speed, regarding the intervals of reference points positioned at the prescribed intervals on a road center line”.

### Advantageous Effects of Invention

According to this invention, it is possible to provide the automatic driving controller capable of appropriately setting the lane boundary lines corresponding to the curve.

Specifically, the control processing is simplified since the interval does not change frequently due to the speed limit according to an embodiment of the present invention. Further, the interval is shortened in response to a situation so that highly accurate control is possible.

### BRIEF DESCRIPTION OF DRAWINGS

FIG. 1 is a flowchart illustrating processing contents in recognition processing 4A of a calculation unit 3.

FIG. 2 is a diagram illustrating an outline of a vehicle equipped with an automatic driving controller of the present invention.

FIG. 3 is a diagram illustrating a hardware configuration of an automatic driving controller 3 according to the present invention.

FIG. 4A is a diagram for describing processing contents of Processing Step S10 in FIG. 1.

FIG. 4B is a diagram for describing processing contents of Processing Step S10 in FIG. 1.

FIG. 5 is a diagram for describing processing contents of Processing Steps S20, S30, and S40 of FIG. 1.

FIG. 6 is a diagram for describing processing contents of Processing Step S50 in FIG. 1.

FIG. 7 is a comparative diagram illustrating a response in a case where an interval between lane boundary line point sequences is constant in the conventional technique and a response in a case where an interval between lane boundary line point sequences is variable in the present invention.

FIG. 8 is a diagram illustrating a response at an intersection according to the present invention.

### DESCRIPTION OF EMBODIMENTS

Hereinafter, an embodiment of the present invention will be described with reference to the drawings.

### Embodiment

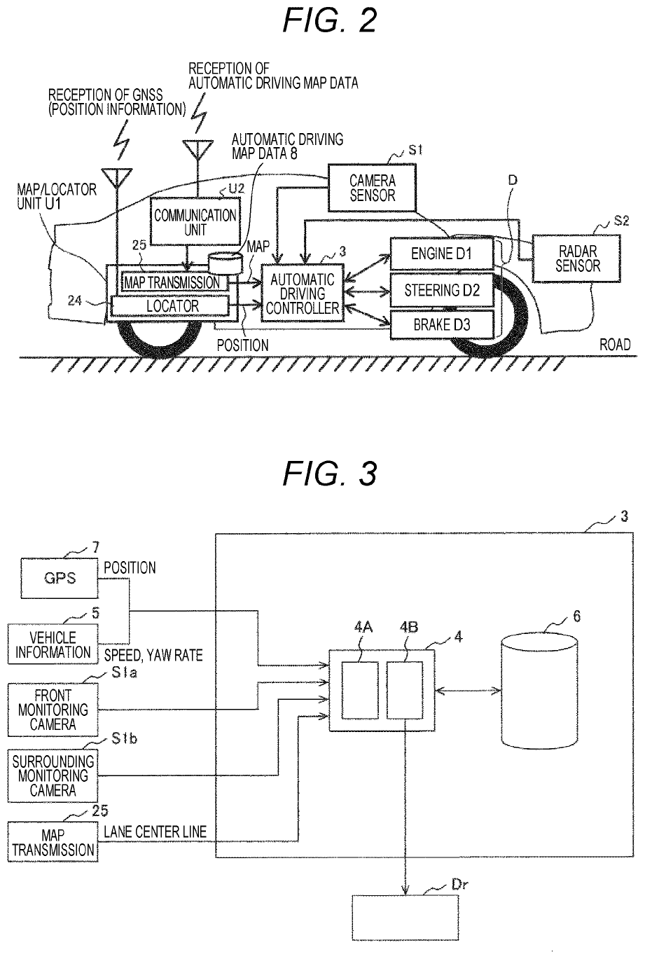

First, an outline of a vehicle equipped with an automatic driving controller of the present invention will be described with reference to FIG. 2.

An automatic driving control system mounted on the actual vehicle illustrated in FIG. 2 is roughly constituted by an automatic driving controller 3, a map/locator unit U1, sensors S, and vehicle control units Dr. Among them, the automatic driving controller 3 obtains map information and position information from the map/locator unit U1 and obtains position information of a three-dimensional object from a camera sensor S1 and position information of the three-dimensional object from a radar sensor S2, the camera sensor S1 and the radar sensor S2 serving as the sensors S, and determines each operation target amount of an engine D1, a steering D2, a brake D3, and the like which are the vehicle control units Dr. Incidentally, the map/locator unit U1 includes a map transmission function 25 and a locator function 24, the locator function 24 receives GNSS (position information) to determine a vehicle position, and the map transmission function 25 includes a communication unit U2 that receives the automatic driving map data 8.

FIG. 3 illustrates a hardware configuration of the automatic driving controller 3 according to the present invention. Although the automatic driving controller 3 has various functions and configurations, only the components essential to the present invention are described herein. For example, the automatic driving controller 3 includes the calculation unit 4 that is a function of a computer and a lane marker storage unit 6 which stores lane information. The automatic driving controller 3 is connected to a GPS 7, a vehicle information detector 5, a front monitoring camera S1a, a surrounding monitoring camera S1b, a locator function 24, and the like, which are measuring devices that give input signals, and obtains inputs. The calculation unit 4 gives a control signal to the vehicle control unit Dr based on these pieces of information to execute automatic driving.

The calculation unit 4 includes recognition processing 4A and control processing 4B. A travel lane and the like for automatic driving is determined in the recognition processing 4A, and each operation target amount of the engine D1, the steering D2, brake D3 and the like, which are the vehicle control unit Dr, is determined in the control processing 4B. By the processing in the control processing 4B, single lane automatic traveling, a driver-triggered lane change, a preceding vehicle follow-up control, and the like are executed. The present invention improves the recognition processing 4A section.

Here, the GPS 7 gives information on a current vehicle position, and the vehicle information detector 5 gives information such as current vehicle speed, yaw rate, and the like. The front monitoring camera S1a and the surrounding monitoring camera S1b provide front and surrounding camera images, which include information such as a lane boundary line and a speed sign. The map transmission function 25 provides information such as a lane center point, a lane width, a road type, and a speed limit. The lane marker storage unit 6 stores, as lane markers, point sequence information of lane center points detected by the front monitoring camera S1a and the surrounding monitoring camera S1b at the past time.

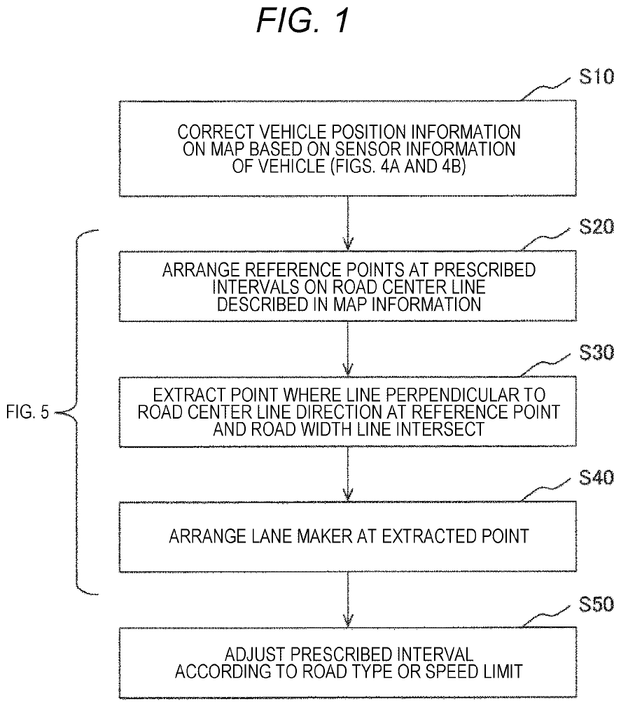

FIG. 1 is a flowchart illustrating the processing contents in the recognition processing 4A of the calculation unit 3. When describing an outline of this flowchart first, this flow is executed at an appropriate fixed cycle in the recognition processing 4A of the calculation unit 3 so that the processing is started.

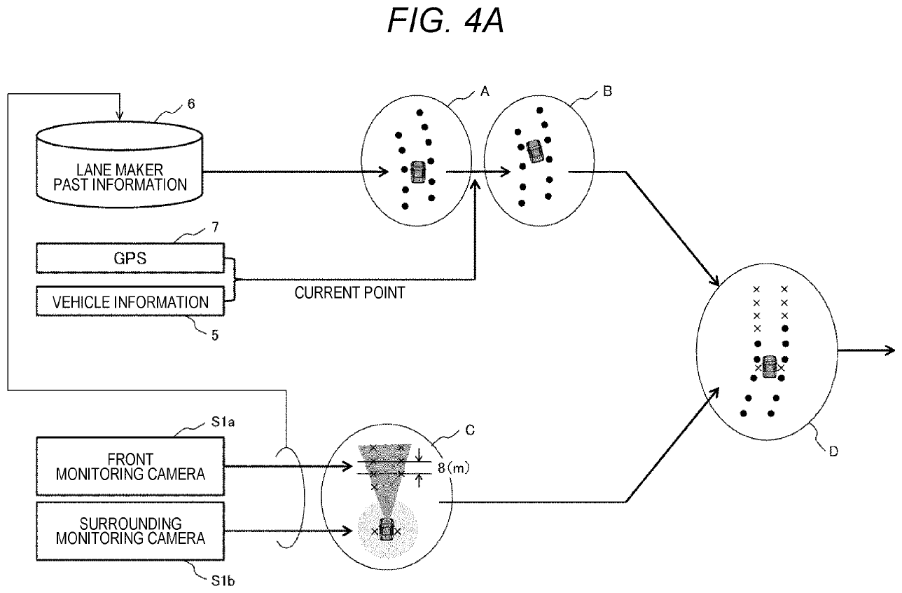

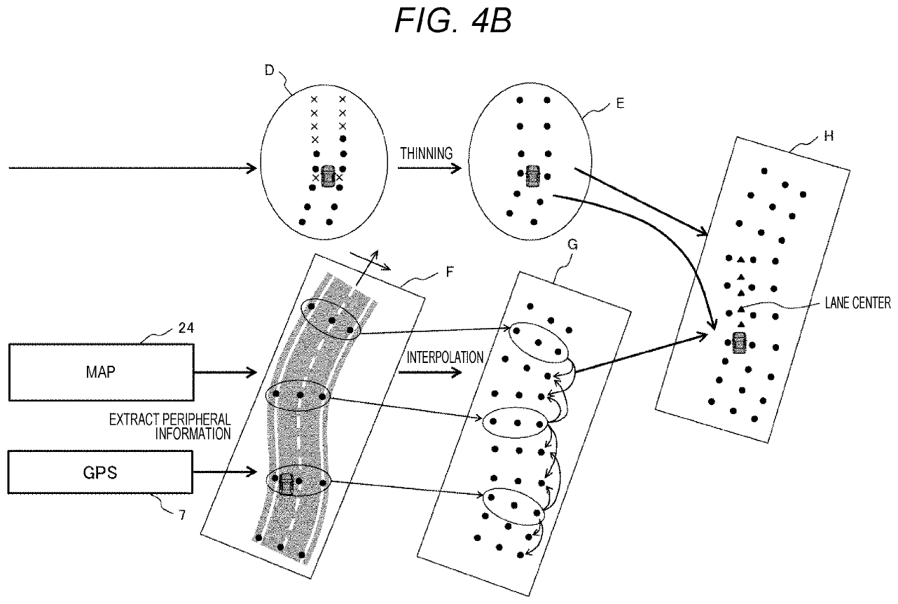

According to the flowchart of FIG. 1, vehicle position information on a map is corrected using vehicle sensor information in the first Processing Step S10. Details of this operation will be described later with reference to FIGS. 4A and 4B.

In Processing Step S20, reference points are positioned at prescribed intervals on a road center line described in map information.

In Processing Step S30, a point where a line perpendicular to a road center line direction and road width lines at the reference points intersect is extracted.

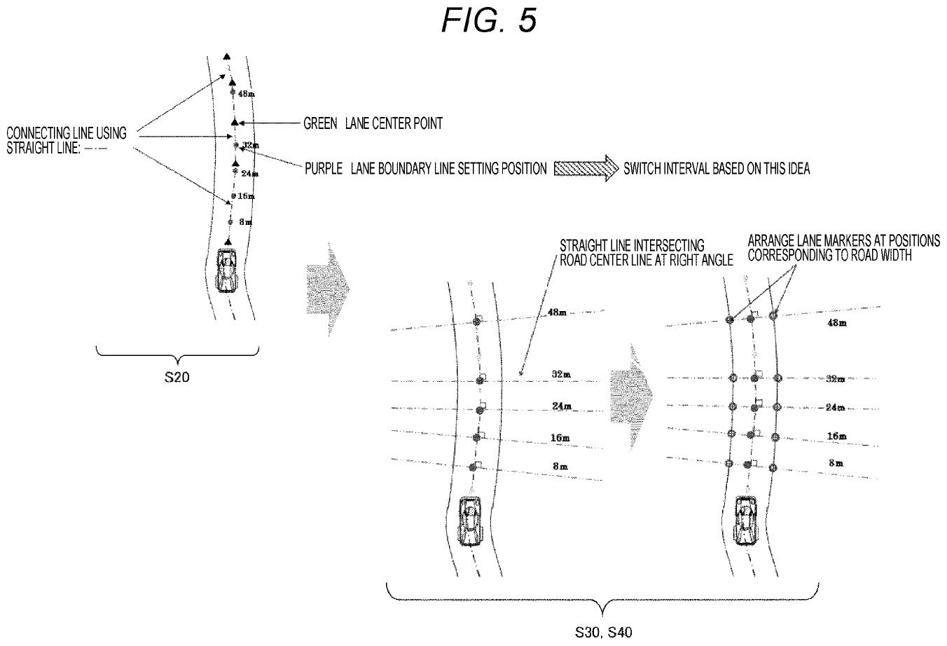

In Processing Step S40, a lane marker is positioned at the extracted point. Details of the operations of Processing Steps S20 to S40 will be described later with reference to FIG. 5.

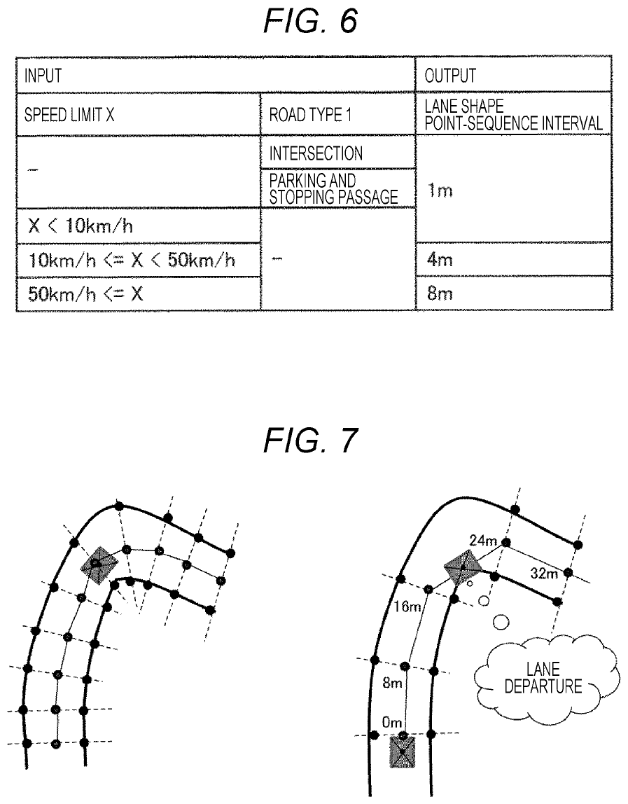

In Processing Step S50, the prescribed interval is adjusted according to a road type or a speed limit. Details of the operation of Processing Step S50 will be described later with reference to FIG. 6.

FIGS. 4A and 4B are diagrams schematically illustrating the first Processing Step S10 (to correct the vehicle position information on the map using the vehicle sensor information) in the above processing. Here, the process of FIG. 4B is performed after FIG. 4A, and thus, the description will start from FIG. 4A.

The sensors and the like that provide the inputs to be used in the recognition processing 4A of the calculation unit 3 are described on the left side of FIG. 4A. The lane marker storage unit 6 in the uppermost part stores information on the lane markers detected by the front monitoring camera S1a and the surrounding monitoring camera S1b described in the lowermost part. The GPS 7 and the vehicle information detector 5 are described in the left middle part of FIG. 4A.

Regarding the information provided by these respective units, the information on the lane markers detected by the front monitoring camera S1a and the surrounding monitoring camera S1b in the lowermost part and the information of the GPS 7 and the vehicle information detector 5 in the left middle part correspond to current information. However, the information on lane markers stored in the lane marker storage unit 6 in the uppermost part is past information (for example, information obtained at time At ago). Incidentally, the lane markers (information on the point sequence of lane center points) detected by the front monitoring camera S1a and the surrounding monitoring camera S1b are positioned, for example, at an interval of 8 (m).

In FIG. 4A, a state A represented by the past information in the lane marker storage unit 6 indicates a vehicle position obtained at the time At ago and boundary line positions as lane markers (●) detected at that time. This illustrates a state where the vehicle travels straight and has almost reached a curve. On the other hand, B is obtained by estimating a state at the current time estimated by correcting positions in the state A using a current position by the GPS 7 and current speed and yaw rate detected from the vehicle information detector 5. B illustrates a state where the vehicle has entered the curve.

Meanwhile, in FIG. 4A, a state represented by lane markers (×) detected by the front monitoring camera S1a and the surrounding monitoring camera S1b is given as C, which illustrates a vehicle position at the current time and positions of the lane markers (×) detected at that time. A state D is a state obtained by adding a past state to C indicating the current state. Lane markers (×) are the latest position information, and lane markers (●) represent past position information or position information estimated from the past. The vehicle is traveling forward during the state D.

In FIG. 4B, the lane markers in the state D are thinned out as illustrated by E. The lane markers at the interval of 8 (m) are thinned. As a result, the amount of data communication from the recognition processing 4A to the control processing 4B is reduced, and a problem of requiring the processing time is improved.

Meanwhile, in the lower part of FIG. 4B, a state F in which peripheral information from the GPS is added to the map information such as the lane center point, lane width, road type, speed limit, and the like provided by the map transmission function 25 is illustrated. Accordingly, it is possible to grasp the degree of the curve of the road on which the vehicle is traveling over a relatively wide range based on the peripheral information from the GPS. However, the number of lane markers is small in the state F, and a state G is obtained by increasing the number of lane markers by interpolation. H is obtained by correcting map information G (the vehicle position information on the map) from the map transmission function 25 using vehicle sensor information E by pattern matching. With this correction, H has information on lane center points (▴) as the map information from the map transmission function 25.

Incidentally, the processes in FIGS. 4A and 4B generates first lane marker information B by correcting the past information of the lane markers (the lane marker storage unit 6) grasped by the cameras using the GPS 7 and the vehicle information 5, and second lane marker information D based on the current information C of the lane makers grasped by the cameras, generates third lane marker information F obtained by adding the lane markers on the map using the lane center points of the GPS 7 and the map transmission function 25, and obtains fourth lane marker information H by pattern matching between the second lane marker information D and the third lane marker information F. This lane marker information H corresponds to obtaining a correction value of a position and a direction of the vehicle.

FIG. 5 is a diagram for describing the processing contents of Processing Steps S20, S30, and S40 of FIG. 1. The processing in Processing Step S20 will be described with reference to the view at the left end of FIG. 5. Here, information on lane center points (▴) is obtained at appropriate intervals along a curve on a map. Further, lane boundary line setting positions (●) are set at an interval of 8 (m) along the curve on the same map. However, the lane boundary line setting positions (●) are set on a line connecting the lane center points (●) with a straight line. As a result, reference points are positioned at prescribed intervals on a road center line described in the map information.

The processing of Processing Steps S30 and S40 will be described with reference to views at the center and right of FIG. 5. Here, straight lines intersecting a road center line, which is a line connecting lane center points (▴) with a straight line, at right angles from lane boundary line setting positions (●) set at an interval of 8 (m) on the road center line are drawn. Then, lane markers are set at positions corresponding to a road width. With the above processing, the state of the curve of the road on which the vehicle needs to travel is estimated.

FIG. 6 is a diagram for describing processing contents of Processing Step S50 of FIG. 1. In the processing of Processing Step S50, for example, 8 (m), which is the interval of the lane boundary line point sequence, is made variable according to a situation. In FIG. 6, an input is a road type or a speed limit, and an output represents a lane shape point sequence interval at this time.

For example, when a speed limit X is 50 (km/h), the lane boundary line point sequence interval is maintained at 8 (m) if an actual traveling speed is 50 (km/h) or higher, but the lane boundary line point sequence interval is 4 (m) within the range between 50 (km/h) and 10 (km/h), and the lane boundary line point sequence interval is 1 (m) when the actual traveling speed is 10 (km/h) or lower. Incidentally, the lane boundary line point sequence interval is set to be short using the speed limit as the reference here, but it is sufficient if the setting is performed such that the interval becomes short in the low speed range. Further, when considering the relationship with the road type, the lane boundary line point sequence interval is set to 1 (m) at an intersection and a parking and stopping passage.

In this manner, in the present invention, the lane boundary line point sequence interval is switched according to the road type or the speed limit. Further, the number of point sequences is not increased even when the interval is switched. If the speed is slow, information on the far side is unnecessary, and there is no speed limit information at the intersection, and thus, it is preferable to switch the interval between the point sequences according to the road type.

FIG. 7 is a comparative diagram illustrating a response in a case where the lane boundary line point sequence interval of 8 (m) is constant in the conventional technique and a response in a case where the lane boundary line point sequence interval is variable in the present invention. In the conventional case, there is a possibility of lane departure when a curve is tight even if a vehicle speed decreases if the interval of 8 (m) is constant. In the present invention, however, it is possible to reduce the possibility of lane departure since the interval is decreased to 4 (m) and further to 1 (m) if the vehicle speed decreases.

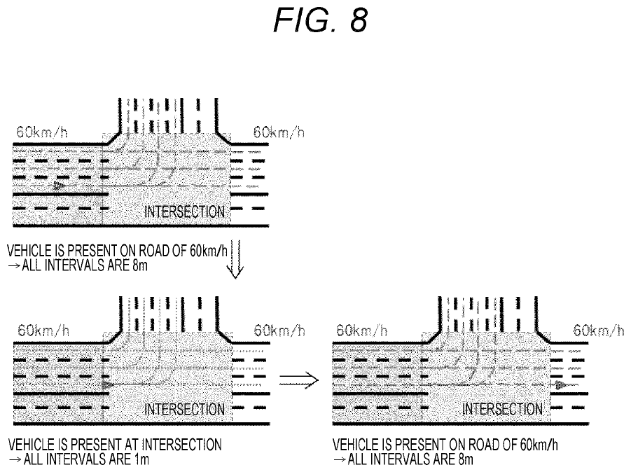

Further, FIG. 8 illustrates a response at the intersection in the present invention. According to this drawing, in a state before entering the intersection (on the upper left in FIG. 8), the vehicle existing on a 60 (km/h) road maintains the lane boundary line point sequence interval of 8 (m). In a state in the middle of entering the intersection (on the lower left in FIG. 8), the vehicle functions with the lane boundary line point sequence interval of 1 (m). In a state after exiting the intersection (on the lower right in FIG. 8), the vehicle existing on the 60 (km/h) road is operated so as to maintain the boundary line point sequence interval at 8 (m) again.

As described above, the interval does not change frequently due to the speed limit according to the embodiment of the present invention, and thus, the control processing is simplified. Further, the interval is shortened in response to a situation so that highly accurate control is possible.

### REFERENCE SIGNS LIST

3 automatic driving controller
4 calculation unit
4A recognition processing
4B control processing
5 vehicle information detector
6 lane marker storage unit
7 GPS
8 automatic driving map data
24 locator function
25 map transmission function
Dr vehicle control unit
D1 engine
D2 steering
D3 brake
S1 camera sensor
S1a front monitoring camera
S1b surrounding monitoring camera
S2 radar sensor
U1 map/locator unit

1. An automatic driving controller for performing automatic driving using map information, the controller comprising:
an input unit for inputting at least vehicle sensor information, vehicle position information on a map, and map information;
a recognition unit that processes the information from the input unit and sets information for automatic driving; and
a control unit which uses the information from the recognition unit to provide operation target amounts for vehicle control units such as an engine, steering, and brakes,
wherein the recognition unit comprises: a first means for correcting the vehicle position information on the map using the vehicle sensor information; a second means for positioning reference points at prescribed intervals on a road described by the map information; and a third means for adjusting the prescribed intervals according to a speed, regarding the prescribed intervals.

2. The automatic driving controller according to claim 1, wherein
the third means of the recognition unit adjusts the prescribed intervals according to a road type, regarding the prescribed intervals.

3. The automatic driving controller according to claim 1, wherein
the recognition unit comprises: a fourth means for extracting, at the reference points, points where a line perpendicular to a road center line direction and road width lines intersect; and a fifth means for positioning lane markers at the extracted points.

4. The automatic driving controller according to claim 1, wherein
the first means generates first lane marker information obtained by correcting past information of lane markers grasped by a camera using GPS and vehicle information, and second lane marker information based on current information of lane markers grasped by the camera, generates third lane marker information obtained by adding lane markers on a map using lane center points obtained using the GPS and a map transmission function, and obtains fourth lane marker information by pattern matching between the second lane marker information and the third lane marker information.

5. The automatic driving controller according to claim 4, wherein
the second lane marker information is subjected to pattern matching with the third lane marker information after a lane marker information thinning process.

6. The automatic driving controller according to claim 4, wherein
the third lane marker information is subjected to pattern matching with the second lane marker information after a lane marker information interpolation process.

7. The automatic driving controller according to claim 1, wherein
the intervals of the reference points positioned on a road center line are set such that the interval of the reference points is short when the speed is low and the interval of the reference points is long when the speed is high.

8. The automatic driving controller according to claim 1, wherein
the intervals of the reference points positioned on a road center line are set such that the interval of the reference points is short at an intersection and a parking and stopping passage.

9. An automatic driving control method for performing automatic driving using at least vehicle sensor information, vehicle position information on a map, and map information, the method comprising:
correcting the vehicle position information on the map using the vehicle sensor information;
positioning reference points at prescribed intervals on a road center line described in the map information;
extracting, at the reference points, points where a line perpendicular to a direction of the road center line and road width lines intersect;
positioning lane markers at the extracted points; and
adjusting the prescribed intervals according to a road type or a speed.

10. The automatic driving control method according to claim 9, wherein
the intervals of the reference points positioned on the road center line are set such that the interval of the reference points is short when the speed is low and the interval of the reference points is long when the speed is high.

11. The automatic driving control method according to claim 9, wherein
the intervals of the reference points positioned on the road center line are set such that the interval of the reference points is short at an intersection and a parking and stopping passage.

12. An automatic driving control method for performing automatic driving using map information, the method comprising
adjusting prescribed intervals according to a road type or a speed, regarding the intervals of reference points positioned at the prescribed intervals on a road center line.

13. The automatic driving control method according to claim 12, wherein
the intervals of the reference points positioned on the road center line are set such that the interval of the reference points is short when the speed is low and the interval of the reference points is long when the speed is high.

14. The automatic driving control method according to claim 12, wherein
the intervals of the reference points positioned on the road center line are set such that the interval of the reference points is short at an intersection and a parking and stopping passage.
